(19) United States
(12) Patent Application Publication
(10) Pub. No.: US 2012/0236341 A1
(43) Pub. Date: Sep. 20, 2012

(54) RECORDING DEVICE, METHOD OF CONTROLLING A RECORDING DEVICE, AND RECORDING MEDIUM

(75) Inventor: Keiko Negishi, Shiojiri-shi (JP)

(73) Assignee: SEIKO EPSON CORPORATION, Tokyo (JP)

(21) Appl. No.: 13/422,179

(22) Filed: Mar. 16, 2012

(30) Foreign Application Priority Data
Mar. 16, 2011 (JP) 2011-057684

(51) Int. Cl. G06K 15/16

(52) U.S. Cl. 358/1.12

(57) ABSTRACT

Processes related to jobs received from a control device can be executed efficiently. An inkjet line printer 1 has a printer-side control unit 27 that, when receiving jobs, gets job-related information related to the received jobs from a host computer 25, and based on the acquired job-related information determines the sequence of processes related to executing the received jobs.

This application claims priority under 35 U. S. C. §119 to Japanese Patent Application No. 2011-57684 filed on Mar. 16, 2011, the entire disclosure of which is expressly incorporated by reference herein.

### BACKGROUND

1. Technical Field

The present invention relates to a recording device that records by a print head (printhead) on a recording medium conveyed in a conveyance direction, to a method of controlling the recording device, and to a recording medium storing a program for controlling the recording device.

2. Related Art

Recording devices that record images by a print head such as a inkjet head on a recording medium conveyed in a conveyance direction are known from the literature. See, for example, Japanese Unexamined Patent Appl. Pub. JP-A-2010-12625.

When the foregoing recording device with a print head continuously receives a plurality of jobs and executes the jobs sequentially, the process related to the jobs needs to be performed as efficiently as possible, but a suitable solution to this problem has not been proposed.

### SUMMARY

The invention enables efficiently executing a process related to the input jobs when jobs are input from a control device.

One aspect of the invention is a recording device that can connect to a control device and has : a conveyance unit that conveys a recording medium; a print head that records to the recording medium conveyed by the conveyance unit; a reception unit that receives a job related to recording an image from the control device; and a control unit that controls the conveyance unit and the print head, and records on the recording medium, by executing the received job, and when executing a plurality of jobs, receives job-related information related to at least one job by the reception unit from the control device, and determines a sequence of processes related to executing the plural jobs, including at least a sequence that stops conveyance by the conveyance unit at a specific target position of the recording medium, based on the received job-related information.

To enable executing plural jobs as much as possible continuously without stopping based on the content of plural input jobs, this aspect of the invention determines the order of the processes related to executing the plural jobs so that operation stops at a recording medium target position enabling recording to continue as long as possible over multiple jobs once recording starts based on job-related information related to at least one job acquired from the control device when a job is executed. As a result, by executing the processes related to executing plural jobs in this order, processes including recording medium conveyance and ink ejection by the head related to plural jobs can be performed sequentially in an efficient order based on the content of the plural jobs input from the control device.

In addition, when recording medium conveyance is stopped in this aspect of the invention, conveyance is stopped at a recording medium target position enabling recording to continue as long as possible over plural jobs once recording starts. In addition, the position of the recording medium after conveyance stops can be accurately controlled, and when, for example, the recording medium is returned in the opposite direction as the conveyance direction to run the next job when a next job is executed, how far the recording medium must be conveyed can be known quickly and efficiently because recording medium conveyance stops at the target position, and the job can be performed efficiently.

In a recording device according to another aspect of the invention, the control unit, based on the job-related information received by the reception unit, determines a sequence of processes related to executing the plural jobs so that a process that stops conveyance by the conveyance unit is executed and conveyance of the recording medium is stopped at the specific target position when executing the last job in the group of plural jobs ends.

The target position of the recording medium, that is, the position where conveyance stops, in this aspect of the invention is the position where executing the last of plural jobs ends. Once recording has started, this enables stopping after all of plural jobs are completed.

Conveying the recording medium unnecessarily can also be prevented after recording the image for the job executed last ends. In addition, when the recording medium is returned in the opposite direction as the conveyance direction to run the next job when a next job is executed, the conveyance distance can be reduced, the time required for conveyance in reverse can be shortened, and throughput can be improved.

Furthermore, because conveying the recording medium unnecessarily can also be prevented and the relative position of the recording medium after conveyance stops can be controlled after recording the image for the job executed last ends, jobs can be executed efficiently when, for example, the recording medium is returned in the opposite direction as the conveyance direction to run the next job when a next job is executed.

Because conveyance precision is required when using a printhead, and particularly an inkjet head, the acceleration and deceleration control required for the motor to rise from a stop to a constant speed is complicated and time-consuming, and require conveying the recording medium. Once operation stops, time is required to resume the rated speed, and conveyance of wasted recording paper that is not used for image recording is required. In addition, if conveyance does not stop at an appropriate position between images, instead of on an image, when waiting for signals from the control device and during regular head cleaning, for example, mechanical error will be apparent where conveyance stops, precise conveyance will be disrupted, and image quality will drop. Throughput will also drop if the motor accelerates and decelerates often. Considering these different conditions, operation preferably continues as much as possible without interruption when running plural jobs.

In addition, if recording starts every time receiving a job starts, operation will soon stop to wait for the next job because the recording process is fast once the rated speed is reached. If recording thus starts and stops frequently, throughput will conversely drop because of the added effect of acceleration and deceleration control. Recording therefore preferably starts once the state and content of plural jobs are known with a process and timing that enable stopping as little as possible.

In a recording device according to another aspect of the invention, at least information indicating the number of jobs that will be received is included in the job-related information; and the control unit determines the specific target position of the recording medium at which conveyance by the conveyance unit stops based on the information indicating the number of jobs.

In this aspect of the invention the target position of the recording medium, that is, the stopping position, is preferably the position where job execution ends based on the number acquired from the job-related information. Once recording starts, operation stops after all of the acquired number of jobs are completed or after a plurality of those jobs are completed.

Furthermore, by knowing the number of jobs included in the job-related information, plural jobs can be executed without stopping, and the target position where conveyance by the conveyance stops can be set appropriately.

A recording device according to another aspect of the invention preferably also has a storage unit with a buffer, and image data for an image to be recorded to the recording medium is included in the job. The control unit stores the image data contained in the job to the buffer by page unit and records the stored image data to the recording medium when executing the job, and determines the specific target position of the recording medium at which conveyance by the conveyance unit stops by page unit.

This aspect of the invention enables determining the target position of the recording medium, that is, the stopping position, by page unit. Because job images are recorded by page unit, conveyance will not stop in the middle of an image.

In this case, the recording device writes the image data contained in the data by page unit to the buffer after receiving data for the job is completed, and the image is recorded based on the image data stored in the buffer. Because the page length is known for each job, this aspect of the invention knows the end position of the page, or knows the position where recording each of the one or plural images in a job ends. Because conveyance by the conveyance stops between executing one job and executing the next job, conveyance stopping in the middle of recording an image based on page unit image data stored in the buffer, and a drop in image quality due to mechanical error, can be desirably prevented.

In a recording device according to another aspect of the invention, information related to image data contained in the jobs is included in the job-related information; and the control unit determines the specific target position of the recording medium at which conveyance by the conveyance unit stops based on the information related to the image data.

This aspect of the invention can appropriately determine the target position where conveyance stops so that recording can continue as long as possible based on the content of the image data contained in the jobs.

In a recording device according to another aspect of the invention, information related to the amount of data in the job is included in the information related to the image data; and the control unit determines the specific target position of the recording medium at which conveyance by the conveyance unit stops based on the information related to the amount of data.

This aspect of the invention enables knowing the position where recording each job ends based on the amount of image data contained in each job. Based on this position, the target position of the recording medium, that is, the stopping position, can be determined based on the amount of data. Stopping in the middle of recording image data can also be avoided.

In a recording device according to another aspect of the invention, information indicating a data transfer rate in communications with the control device is included in the job-related information; and the control unit determines the specific target position of the recording medium at which conveyance by the conveyance unit stops based on the data transfer rate information.

This aspect of the invention enables predicting the timing when the reception unit finishes receiving the data for each job. Based on this timing, the order of processes related to executing the plural jobs can be determined so that receiving the data for each job is completed by the time executing each job starts. This enables executing plural jobs continuously as much as possible without stopping to wait for data.

Because when receiving each job will be completed can be known based on the data transfer rate, the target position of the recording medium where conveyance is expected to stop to wait for reception, that is, the stopping position, can be determined. Stopping to wait for reception in the middle of recording data can also be avoided.

Furthermore, because the order of job processes is determined so that reception of data for each job is completed when each job starts, the job processes can be sequentially executed in an efficient order according to the state of receiving data for each job by executing the job processes in this order.

In a recording device according to another aspect of the invention, information related to the length in the conveyance direction of the image recorded to the recording medium by executing each job is included in the job-related information; and the control unit determines the specific target position of the recording medium at which conveyance by the conveyance unit stops based on the information related to each length.

This aspect of the invention can predict the time required to execute each job based on the information related to the length in the conveyance direction of the image recorded to the recording medium by executing the job. Based on this predicted time, the order of processes related to executing the plural jobs can be determined so that receiving the data for each job is completed by the time executing each job starts. This enables executing plural jobs continuously as much as possible without stopping to wait for data.

Because the length in the conveyance direction of the recording paper when each job is recorded is known, the target position of the recording medium, that is, the stopping position, can be determined based on the position where recording each job ends. Stopping in the middle of recording data can also be avoided.

Furthermore, the time required to execute the jobs can be appropriately predicted based on information related to the length in the conveyance direction of the image recorded to the recording medium by executing the jobs included in the job-related information, and the conveyance speed of the recording medium; and using the time required to execute the jobs predicted from the time when input of data related to each job will be completed when data related to the jobs is input sequentially, the order of processes related to the input jobs can be determined so that receiving the data related to each job is completed when executing each job starts. Stopping to wait for data in the middle of recording can therefore be prevented.

Another aspect of the invention is a method of controlling a recording device that has a conveyance unit that conveys a recording medium, and a print head that records to the recording medium conveyed by the conveyance unit, and can connect to a control device, the control method including steps of : receiving a job related to recording an image from the control device; operating the conveyance unit and the print head and recording based on the received job; receiving job-related information related to at least one job from the control device; and determining a sequence of processes related to executing the plural jobs, including at least a sequence that stops conveyance by the conveyance unit at a specific target position of the recording medium, based on the received job-related information.

By determining the order of the job-related processes to reflect the content of the input jobs based on the job-related information acquired from the control device before the jobs are actually executed, this aspect of the invention can sequentially execute the job-related processes in an efficient order according to the content of the jobs input from the control device by executing the job-related processes in this order.

Another aspect of the invention is a storage medium that stores a program executed by a control unit that controls parts of a recording device that has a conveyance unit that conveys a recording medium, and a print head that records to the recording medium conveyed by the conveyance unit, and can connect to a control device, the program causing the control unit to perform steps including: receiving a job related to recording an image from the control device; operating the conveyance unit and the print head and recording on the recording medium based on the received job; receiving job-related information related to at least one job from the control device when recording a plurality of jobs; and determining a sequence of processes related to executing the jobs, including at least a sequence that stops conveyance by the conveyance unit at a specific target position, based on the received job-related information.

### EFFECT OF THE INVENTION

The invention enables efficiently executing job-related processes for jobs input from a control device.

### BRIEF DESCRIPTION OF THE DRAWINGS

FIG. 1 shows the configuration of an inkjet printer.

FIG. 2 shows label paper.

FIG. 3 shows the functional configuration of a recording system.

FIG. 4 shows label paper.

FIG. 5 is a flow chart of recording system operation.

FIG. 6 shows the content of a selected procedure.

FIG. 7 is a flow chart of recording system operation.

FIG. 8 describes the process performed in step SD2 in FIG. 7.

### DESCRIPTION OF EMBODIMENTS

A preferred embodiment of the present invention is described below with reference to the accompanying figures.

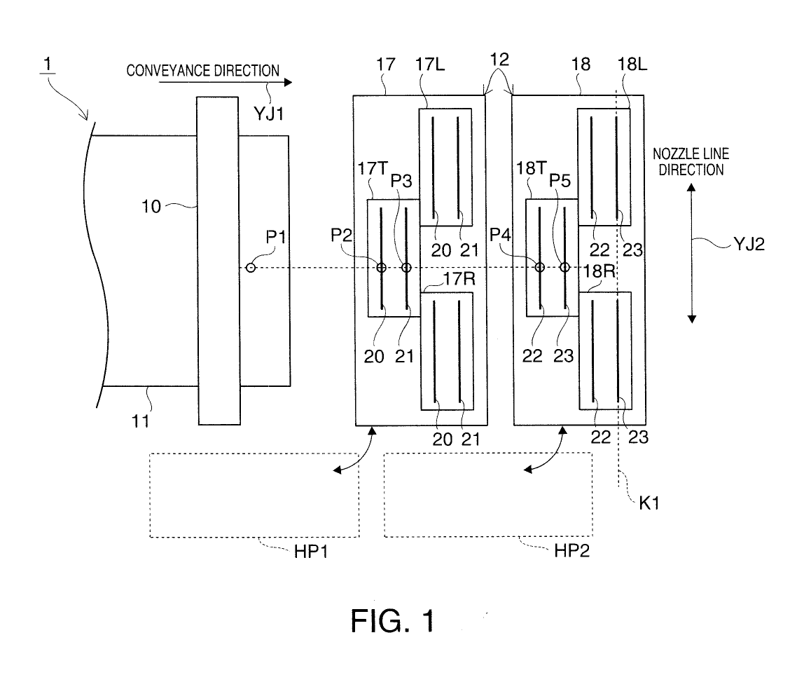

FIG. 1 schematically describes the configuration of an inkjet line printer 1 (recording device) according to this embodiment of the invention.

The inkjet line printer 1 is an inkjet printer with a line printhead that records images on a recording medium 11 by ejecting ink from an inkjet line head 12 (print head) onto the recording medium 11 while conveying the recording medium 1 1 in the paper feed direction (indicated by arrow YJ1 in FIG. 1) with a paper feed roller 10.

The inkjet line printer 1 can record images at least on label paper 14, which is a recording medium 11 as described below.

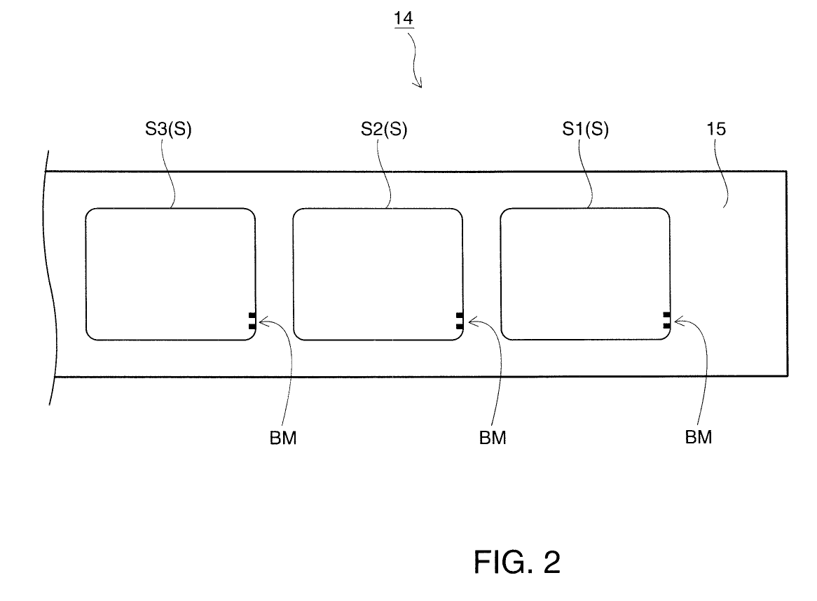

FIG. 2 schematically describes the label paper 14.

As shown in FIG. 2, the label paper 14 has a long, narrow shape with seal parts S (labels) formed with a specific gap therebetween on the recording surface 15. A seal (label) is affixed at the location of each seal part S, and can be peeled away from the surrounding waste matrix. The length of the seal parts S in the conveyance direction is uniform, and the interval between seal parts S is also uniform. The inkjet line printer 1 records an image in each of the seal parts S formed on the label paper 14.

When the inkjet line printer 1 records on the label paper 14, the label paper 14 is set in the inkjet line printer 1 so that the length of the label paper 14 is aligned with the conveyance direction, and specific images are recorded desirably to the seal parts S as the label paper 14 is conveyed in the conveyance direction.

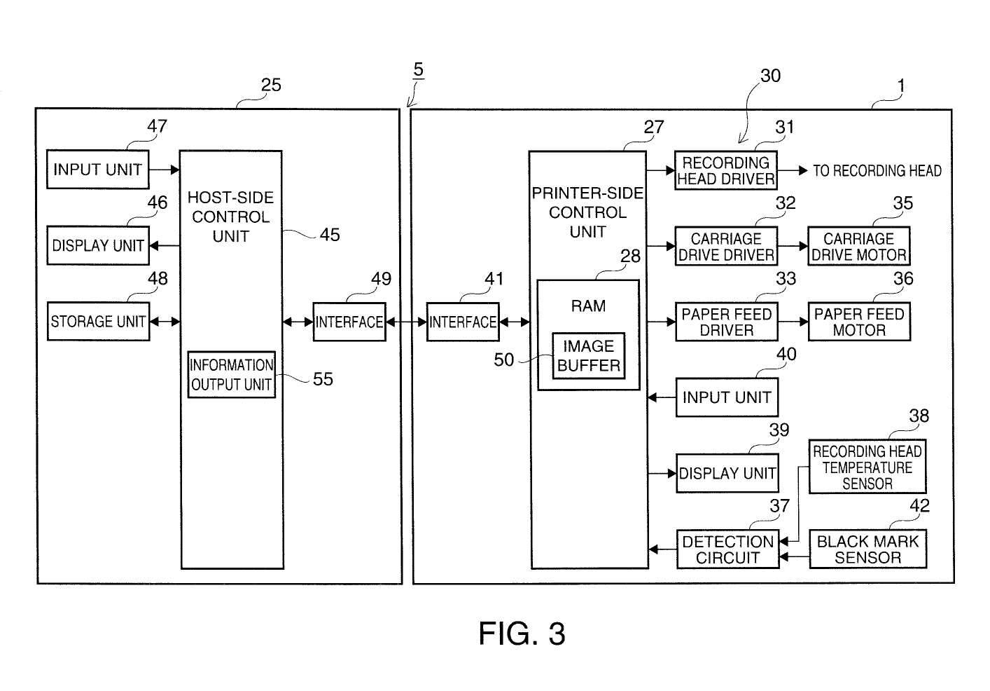

As shown in FIG. 2, a black mark BM is formed on each seal part S. These black marks BM are black marks of a specific shape formed at a specific position on the seal parts S. While not shown in FIG. 1, the inkjet line printer 1 has a black mark sensor 42 (FIG. 3) that optically detects the black marks BM formed on the seal parts S of the conveyed label paper 14 at a specific position on the label paper 14 conveyance path. Based on output from the black mark sensor 42, the printer-side control unit 27 (control unit) described below detects when a black mark BM reaches the sensor position, and adjusts the position of the recording medium 11 or adjusts the conveyance process based on the result of black mark BM detection.

The seal parts S on which images are recorded are used as labels that are affixed to products, for example.

As shown in FIG. 1, the inkjet line printer 1 has an upstream head unit 17 and a downstream head unit 18.

The upstream head unit 17 has three staggered recording heads, upstream top recording head 17T, upstream left recording head 17L, and upstream right recording head 17R. The downstream head unit 18 similarly has three staggered recording heads, downstream top recording head 18T, downstream left recording head 18L, and downstream right recording head 18R.

A black nozzle line 20, and a cyan nozzle line 21 disposed downstream from the black nozzle line 20, are disposed to the upstream top recording head 17T.

The black nozzle line 20 is a nozzle line having nozzles (not shown) that eject ink as fine ink droplets formed in the nozzle line direction (indicated by arrow YJ2 in FIG. 1), which is perpendicular to the conveyance direction. Ink is supplied to the black nozzle line 20 from a black (K) ink cartridge (not shown), and the upstream top recording head 17T pushes ink supplied from the black (K) ink cartridge by an actuator such as a piezoelectric device toward the recording medium 11, ejecting fine ink droplets from specific nozzles.

Similarly to the black nozzle line 20, the cyan nozzle line 21 is a nozzle line of nozzles formed in the nozzle line direction, and has ink supplied from a cyan (C) ink cartridge (not shown).

The upstream right recording head 17R and the upstream left recording head 17L are configured identically to the upstream top recording head 17T, and have a black nozzle line 20, and a cyan nozzle line 21 disposed on the downstream side of the black nozzle line 20, respectively.

A magenta nozzle line 22, and a yellow nozzle line 23 located downstream from the magenta nozzle line 22, are disposed to the downstream top recording head 18T.

Like the black nozzle line 20, the magenta nozzle line 22 is a nozzle line of nozzles formed in the nozzle line direction, and has ink supplied from a magenta (M) ink cartridge (not shown).

Like the black nozzle line 20, the yellow nozzle line 23 is a nozzle line of nozzles formed in the nozzle line direction, and has ink supplied from a yellow (Y) ink cartridge (not shown).

The downstream right recording head 18R and downstream left recording head 18L are configured identically to the downstream top recording head 18T, and respectively have a magenta nozzle line 22 and a yellow nozzle line 23 disposed on the downstream side of the magenta nozzle line 22.

Note that the recording heads and the nozzle lines of the recording heads are shown in FIG. 1 for convenience of description, but the recording heads are actually configured to eject ink vertically downward from the nozzles of the nozzle lines, and the various parts are disposed to achieve this configuration.

The inkjet line printer 1 ejects ink and forms dots on the recording medium 11, and records images by the combination of dots. The basic operation for forming a single dot on the recording medium 11 is described briefly using FIG. 1.

Forming a dot of a specific color at a desired position P1 on the recording medium 11 when the recording medium 11 is set to a position as shown in FIG. 1 is described below. The specific color is a color that is achieved by ejecting specific amounts of black (K), cyan (C), magenta (M), and yellow (Y) ink. Position P2 in FIG. 1 is the position where position P1 on the conveyed recording medium 11 passes the black nozzle line 20 of the upstream top recording head 17T. Position P3, position P4, and position P5 are similar positions.

The inkjet line printer 1 conveys the recording medium 11 in a specific direction at a predetermined constant speed while forming dots on the recording medium 11. Conveyance proceeds in the conveyance direction of the recording medium 11 from the position shown in FIG. 1, and the inkjet line printer 1 ejects a specific amount of black (K) ink timed to position P1 on the recording medium 11 reaching the position corresponding to position P2. The inkjet line printer 1 likewise ejects a specific amount of cyan (C) ink timed to position P1 on the recording medium 11 reaching the position corresponding to position P3, ejects a specific amount of magenta (M) ink timed to position P1 on the recording medium 11 reaching the position corresponding to position P4, and ejects a specific amount of yellow (Y) ink timed to position P1 on the recording medium 11 reaching the position corresponding to position P5. Specific amounts of black (K), cyan (C), magenta (M), and yellow (Y) ink are thus ejected to position P1 on the recording medium 11, and a dot of a specific color is formed at position P1.

The positions of the recording heads are thus fixed during the process related to recording an image in the inkjet line printer 1 according to this embodiment of the invention, the recording medium 11 moves relative to the stationary recording heads, ink is desirably ejected from the recording heads to form dots, and an image is recorded.

The inkjet line printer 1 is also capable of performing a flushing process.

Ink viscosity can increase due to drying and result in ink ejection problems in the nozzles formed in each nozzle line, particularly in nozzles that are not used and nozzles that are used infrequently. Flushing is an operation that is performed to prevent such ejection problems.

More specifically, the upstream head unit 17 and the downstream head unit 18 are mounted respective carriages. The upstream head unit 17 can move to home position HP1 shown FIG. 1, and the downstream head unit 18 can move to home position HP2, by the carriage.

A box-like cap with an open top is disposed to home position HP1. This cap receives ink ejected from the recording heads of the upstream head unit 17 when positioned to home position HP1, and can discharge the ejected ink as waste ink into a collection tank. An identical cap is also disposed to home position HP2.

To flush the recording heads of the upstream head unit 17, the upstream head unit 17 is first moved by the carriage to the home position HP1. A specific amount of ink is then ejected from nozzles of the recording heads included in the upstream head unit 17 (all nozzles or only specific nozzles selected based on usage frequency, for example). Ink that has increased in viscosity is thus expelled from the nozzles, and ejection problems are prevented. When flushing is completed, the upstream head unit 17 returns to a specific position from the home position HP1, enabling execution of the process related to recording an image. The downstream head unit 18 is flushed in the same way.

FIG. 3 shows the functional configuration of a recording system 5 according to this embodiment of the invention.

As shown in FIG. 3, the recording system 5 includes a inkjet line printer 1, and a host computer 25 that can connect to the inkjet line printer 1 and controls the inkjet line printer 1.

The inkjet line printer 1 includes a printer-side control unit (control unit) and a driver circuit unit 30.

The printer-side control unit 27 centrally controls parts of the inkjet line printer 1, and includes a CPU as an operating unit, a basic control program that can be executed by the CPU, ROM that nonvolatilely stores this basic control program and data, RAM 28 (storage unit) that temporarily stores the program executed by the CPU and data related to the program, and other peripheral circuits. The printer-side control unit 27 can also perform timekeeping operations based on a reference clock generated by an oscillator not shown.

The driver circuit unit 30 includes a recording head driver 31, carriage drive driver 32, and paper feed driver 33.

The recording head driver 31 is connected to each recording head, and as controlled by the printer-side control unit 27 drives the actuators of each recording head to eject the required amount of ink from the nozzles.

The carriage drive driver 32 is connected to a carriage drive motor 35, and as controlled by the printer-side control unit 27 moves the upstream head unit 17 and/or the downstream head unit 18 from the position where the recording operation can be performed to home position HP1, HP2, and from the home position HP1, HP2 to the position where the recording operation can be performed.

The paper feed driver 33 is connected to the paper feed motor 36, outputs a drive signal to the paper feed motor 36, and causes the paper feed motor 36 to operate only the amount specified by the printer-side control unit 27. As the paper feed motor 36 operates, the paper feed roller 10 turns, and the recording medium 11 is conveyed a specific amount in the conveyance direction or the reverse of the conveyance direction.

In this embodiment of the invention the printer-side control unit 27 and the paper feed driver 33, paper feed motor 36, and paper feed roller 10 cooperate to function as a conveyance unit that conveys the recording medium 11.

The detection circuit 37 is connected to a recording head temperature sensor 38 and the black mark sensor 42. The recording head temperature sensor 38 is disposed near one of the recording heads, detects the temperature of the recording head, and outputs to the printer-side control unit 27. Based on the output from the recording head temperature sensor 38, the printer-side control unit 27 detects the temperature of the recording head.

The black mark sensor 42 optically reads the black mark BM formed on each seal part S of the label paper 14, and outputs the detection result to the printer-side control unit 27.

A display unit 39 is connected to the printer-side control unit 27, and operation of multiple LEDs disposed to the display unit 39 can be controlled by the printer-side control unit 27. An input unit 40 is also connected to the printer-side control unit 27, and operating signals are input from the input unit 40 to the printer-side control unit 27 when the operator operates switches disposed to the input unit 40.

The communication interface 41 includes a connector that is connected to the host computer 25, and an interface circuit that implements a specific communication protocol through the connector. The communication interface 41 and the host computer 25 are connected using a standard such as IEEE 1284, USB (Universal Serial Bus), or IEEE 1394. Note that a configuration in which the communication interface 41 is connected to the host computer 25 through a LAN (local area network) using a wired or wireless communication path is also conceivable. In this case a plurality of host computers 25 could be connected to the inkjet line printer 1.

The communication interface 41 and the printer-side control unit 27 cooperate to function as a reception unit that receives jobs (control commands (including data such as image data)) and job-related information (described below) from the host computer 25.

The host computer 25 includes a host-side control unit 45 (information control unit), display unit 46, input unit 47, storage unit 48, and communication interface 49.

The host-side control unit 45 centrally controls the parts of the host computer 25, and like the printer-side control unit 27 includes a CPU, ROM, RAM, and peripheral circuits. The host-side control unit 45 also has an information output unit 55 described below.

The display unit 46 is an LCD panel or organic electroluminescent panel, for example, and displays information on the display panel as controlled by the host-side control unit 45.

The input unit 47 is connected to input devices, and outputs output signals from the input devices to the host-side control unit 45.

The storage unit 48 is a storage device such as a hard disk drive or EEPROM device, and stores data rewritably.

Like the communication interface 41 described above, the communication interface 49 exchanges signals with the inkjet line printer 1 as controlled by the host-side control unit 45.

The printer-side control unit 27 controls parts of the driver circuit unit 30 based on control commands input from the host computer 25, and performs the operation that records images on the recording medium 11.

A printer control program such as a printer driver for controlling the inkjet line printer 1 is installed to the host computer 25. The host-side control unit 45 outputs appropriate control commands to the inkjet line printer 1 by reading and running the printer control program.

The basic operation of the recording system 5 when recording an image on the label paper 14 described above is described next.

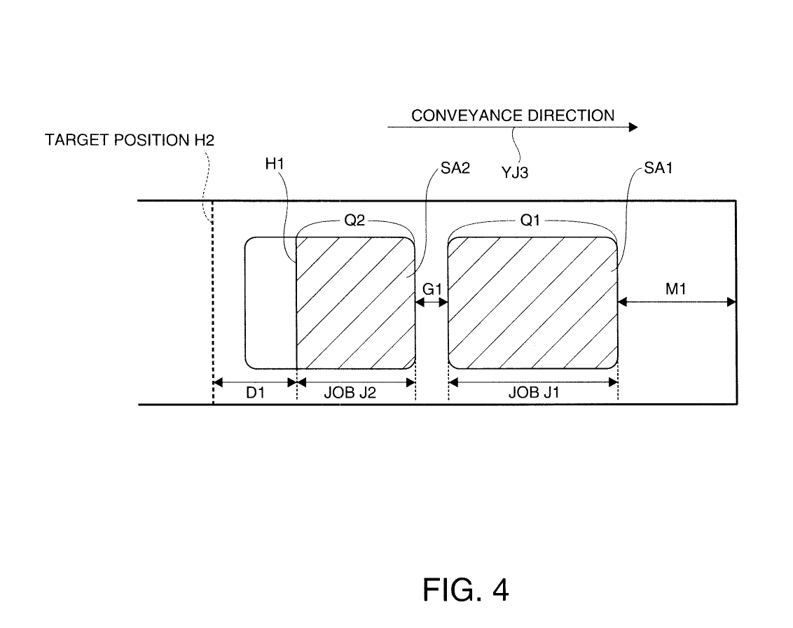

FIG. 4 schematically describes the label paper 14 in order to describe the basic operation of the recording system 5.

The label paper 14 shown in FIG. 4 is set in the inkjet line printer 1 so that the right end in FIG. 4 is the leading end and the length of the paper matches the conveyance direction, and is conveyed appropriately in the direction indicated by arrow YJ3 as the conveyance direction.

In the example in FIG. 4, images are sequentially recorded to two seal parts S, seal part S1 and seal part S2, an image is recorded to area SA1 of seal part S1, and an image is recorded to area SA2 of seal part S2. Area SA1 of seal part S1 is all of seal part S1 (the shaded area in seal part S1 in FIG. 4). Area SA2 extends a specific distance in the reverse of the conveyance direction from the end on the conveyance direction side of seal part S2 (the shaded portion of seal part S2 in FIG. 4).

When recording an image to label paper 14 in the example in FIG. 4, the host computer 25 first outputs a set of control commands that cause the inkjet line printer 1 to execute a single process related to recording an image in area SA1 of seal part S1, and then outputs a set of control commands for executing a single process related to recording an image in area SA2 of seal part S2.

The single process related to recording an image in one seal part S is the process from starting to ending recording an image on one seal part S, that is, a process of ejecting the necessary amount of ink from the recording heads while conveying the label paper 14 and recording an image on one seal part S.

The printer-side control unit 27 of the inkjet line printer 1 manages the single processes related to recording images on seal part S1 and seal part S2 as two jobs, job J1 and job J2. Executing a job as used below means sequentially executing the set of control commands related to recording an image on a specific seal part S, and executing the single process related to recording an image on the specific seal part S. For example, executing job J1 means sequentially executing the set of control commands related to recording an image to the area SA1 of seal part S1, and recording an image in area SA1 of seal part S1, and executing job J2 means sequentially executing the set of control commands related to recording an image to the area SA2 of seal part S2, and recording an image in area SA2 of seal part S2.

When control commands for job J1 and control commands for job J2 are input, the printer-side control unit 27 conveys the recording medium to the starting position for job J1 (the position where the recording head starts ejecting ink onto seal part S1) with consideration for the margin M1 formed between the leading end of the label paper 14 and the leading end of seal part S1, and then runs the job J1.

In addition to the image data for the image to be recorded to area SA1 of seal part S1, the control commands related to job J1 include a control command for writing the image data to a specific area in the image buffer 50 formed in a specific area of RAM 28, and a control command for recording an image based on the image data written to the image buffer 50.

Based on these commands, the printer-side control unit 27 writes the image data for the image to be recorded to area SA1 of seal part S1 in page units (the units of area SA1 and area SA2 in this embodiment) to the specific area in the image buffer 50, then records the image to the area SA1 of seal part S1 based on the image data stored in the image buffer 50 while conveying the label paper 14 in the conveyance direction.

Writing the image data in page units to the image buffer 50 means storing all of the image data for one image to an area equal to one page unit in the image buffer 50. As known from the literature, when a single image is recorded in the page mode as in this embodiment of the invention, all of the image data for the image is written in page units to the image buffer 50, and the entire image is recorded to the recording medium based on the image data stored in the image buffer 50.

Images are thus recorded in a page mode by the inkjet line printer 1 according to this embodiment of the invention. More specifically, images are recorded after all image data has been written to the image buffer 50. This means that for the inkjet line printer 1 to execute one job, inputting all control commands related to that one job from the host computer 25 and writing all image data in page units to the image buffer 50 must be possible before the job is executed.

The printer-side control unit 27 then records an image to the area SA2 of seal part S2 by executing job J2 continuously to execution of job J1.

As described above, the upstream head unit 17 and downstream head unit 18 are separated from each other in the conveyance direction in the inkjet line printer 1 according to this embodiment of the invention. As a result, there is a period in which recording an image (ejecting ink) to part of seal part S1 by the recording heads of the downstream head unit 18, and recording an image (ejecting ink) to part of seal part S2 by the recording heads of the upstream head unit 17, occur simultaneously. In other words, there is an overlap between when job J1 ends and when job J2 starts.

An inkjet line printer 1 according to this embodiment of the invention is thus configured to execute input jobs continuously when a plurality of jobs are input from a host computer 25.

In order to efficiently acquire job-related information related to the jobs input from the host computer 25, and execute each job and any processes performed in connection with each job based on the job-related information, the inkjet line printer 1 also determines the sequence of processes related to executing the input jobs before the jobs are performed.

Operation of the inkjet line printer 1 and the host computer 25 is described below using two examples, example 1 and example 2.

### EXAMPLE 1

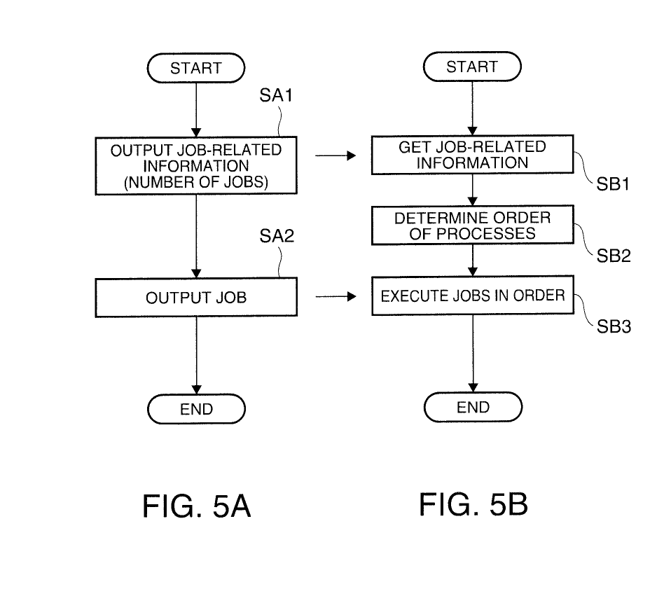

FIG. 5 is a flow chart showing the operation of the inkjet line printer 1 and host computer 25 in example 1. FIG. 5(A) shows the operation of the host computer 25, and FIG. 5(B) shows the operation of the inkjet line printer 1.

The processes related to job execution are performed efficiently using a simpler process in example 1 than in example 2 described below.

In example 1 described next, job J1 related to recording an image to area SA1 of seal part S1, and job J2 related to recording an image to area SA2 of seal part S2, are input sequentially from the host computer 25 to the inkjet line printer 1, and the inkjet line printer 1 sequentially executes the input job J1 and job J2 as shown in FIG. 4.

Note also that in the flow chart shown in FIG. 5 the functions of the information output unit 55 and printer-side control unit 27 are achieved by the cooperation of hardware and software, such as by a CPU executing a specific program.

As shown in FIG. 5, before outputting job J1 and job J2, the information output unit 55 of the host-side control unit 45 of the host computer 25 outputs job-related information, including information denoting the number of jobs to be output, to the inkjet line printer 1 (step SA1).

Because there are two jobs, job J1 and job J2, scheduled to be output in this example, the information output unit 55 outputs information indicating the number of jobs is two to the printer-side control unit 27 of the inkjet line printer 1 in step SA1.

Based on the input job-related information, the printer-side control unit 27 gets the information denoting the number of jobs scheduled to be input (step SB1).

The printer-side control unit 27 then determines the sequence of the processes related to executing each input job (step SB2).

Determining the sequence of the processes related to executing each input job means determining the order and the content of the specific processes of each job and the processes to be performed in conjunction with executing each job in order to sequentially perform the input jobs, and scheduling the processes.

The process performed in step SB2 is described next.

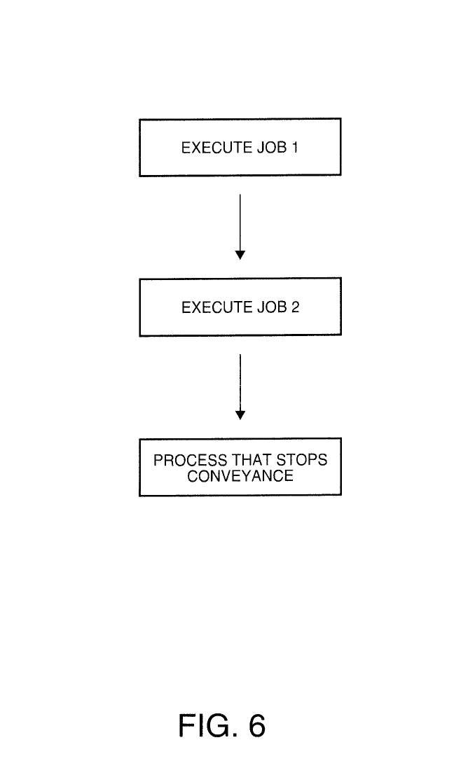

FIG. 6 shows an example of the content of the steps determined in step SB2.

As shown in FIG. 6, knowing in step SB2 that two jobs will be input, the printer-side control unit 27 determines the sequence of processes so that the processes are sequentially performed to perform in order: executing the first job, executing the second job (which is the last job in this example), and then executing the process of stopping conveyance. That the second job is the last job can be detected based on the information denoting the number of jobs that is included in the job-related information.

When the processes are executed in this order, the process of stopping conveyance is executed in conjunction with the end of job J2, which is the last of the two jobs, immediately after recording the image to area SA2 of seal part S2 is completed. This enables stopping media conveyance with the minimum paper feed required after recording an image to area SA2 is completed.

This is described more specifically with reference to FIG. 1 and FIG. 4. Referring to FIG. 1, the position corresponding to a line extending in the nozzle line direction through the yellow nozzle lines 23 of the downstream left recording head 18L and downstream right recording head 18R in the downstream head unit 18 is a reference position K1. When recording an image to area SA2 of seal part S2 is completed, the position corresponding to the edge H1 of area SA2 on the opposite end as the conveyance direction is at reference position K1.

When the processes are performed in the order shown in FIG. 6, the position corresponding to edge H1 on the label paper 14 (FIG. 4) is at the position corresponding to the reference position K1 (FIG. 1) of the inkjet line printer 1, and the process of stopping label paper 14 conveyance is performed immediately after recording the image to area SA2 of seal part S2 ends. As a result, media conveyance can be stopped after conveying the media the minimum distance required after recording an image to area SA2 ends.

In the process of stopping label paper 14 conveyance, the printer-side control unit 27 sets a target position H2 (FIG. 4) on the label paper 14, and the process of stopping conveyance ends when this target position H2 reaches the reference position K1 (FIG. 1). This target position H2 is defined as a position conveyed distance D1 (FIG. 4) after recording an image to area SA2 ends. More specifically, after recording an image to area SA2 of seal part S2 ends (after job J2, which is the second job, ends), the printer-side control unit 27 conveys the label paper 14 distance D1, and then stops conveyance completely. Conveyance this distance D1 is required to gradually reduce the paper feed speed in order to completely stop label paper 14 conveyance, and is the shortest distance the label paper 14 must be conveyed after job J2 ends.

In this process of stopping label paper 14 conveyance, the printer-side control unit 27 thus completely stops conveyance when the target position H2 reaches the reference position K1 after recording an image to area SA2 ends. As a result, conveying the label paper 14 unnecessarily after completing recording the image related to the last job executed can be prevented, and the position of the label paper 14 after conveyance stops can be accurately managed. As a result, when a new job is executed, how far the label paper 14 must be conveyed in reverse in order to perform the new job can be managed appropriately, and the media can be conveyed efficiently. Jobs can be processed efficiently in this case because there is no need to perform an operation such as conveying the label paper 14 a predetermined distance and detecting the position of a seal part S using output from the black mark sensor 42 during media conveyance. In addition, because the media is conveyed only the required minimum in the conveyance direction after recording an image to area SA2 is completed, the conveyance distance can be minimized when the label paper 14 is conveyed in reverse of the conveyance direction to execute a new job, the time required for conveyance in reverse can be shortened, and throughput can be improved.

In the process of step SB2, the printer-side control unit 27 thus determines the order in which processes are executed so that the processes can be efficiently executed in sequence based on information indicating the number of jobs included in the job-related information acquired from the host computer 25. This is possible by acquiring job-related information including information denoting the number of jobs before the jobs are executed.

After outputting the job-related information, the host computer 25 sequentially outputs job J1 and job J2 (step SA2). Outputting a job is outputting the control commands related to the job.

When job J1 and job J2 are input, the printer-side control unit 27 sequentially performs the processes in the process order determined in step SB2.

More specifically, the printer-side control unit 27 does job J1, does job J2 continuously to job J1, and after job J2 is completed, performs the process of stopping label paper 14 conveyance.

### EXAMPLE 2

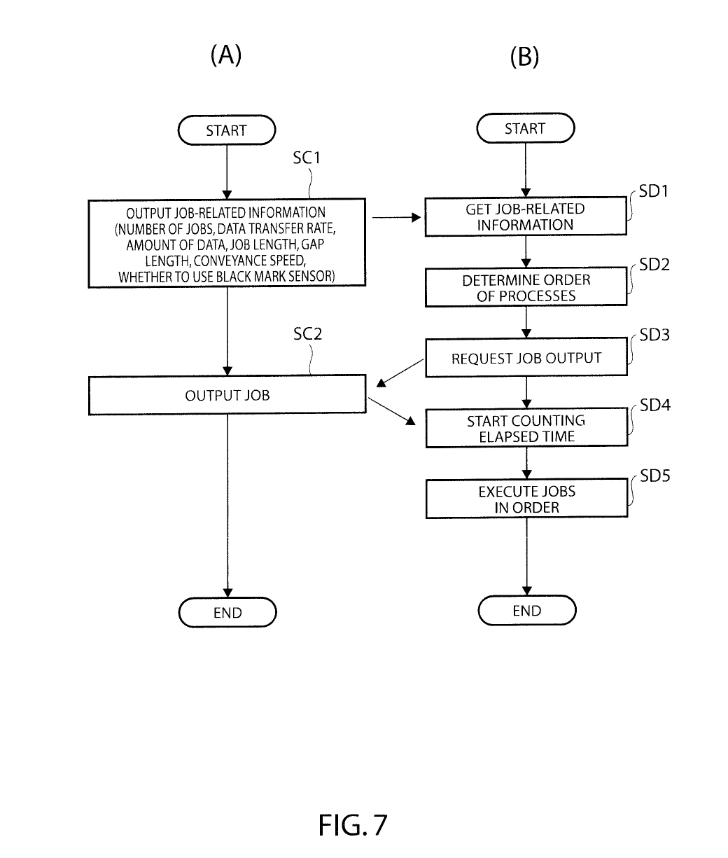

FIG. 7 is a flow chart showing the operation of the inkjet line printer 1 and host computer 25 in example 2. (A) in FIG. 7 shows the operation of the host computer 25, and (B) in FIG. 7 shows the operation of the inkjet line printer 1.

As in example 1, in example 2 job J1 related to recording an image to area SA1 of seal part S1, and job J2 related to recording an image to area SA2 of seal part S2, are input sequentially from the host computer 25 to the inkjet line printer 1, and the inkjet line printer 1 sequentially executes the input job J1 and job J2.

As shown in FIG. 7, the information output unit 55 of the host computer 25 outputs job-related information to the inkjet line printer 1 before outputting the jobs (step SC1).

This job-related information includes at least information indicating the number of jobs scheduled to be output, the data transfer rate of communications between the host computer 25 and the inkjet line printer 1, the amount of data in the control commands related to each job scheduled to be output, the job length (described below) of each job scheduled to be output, the gap length (described below), and the conveyance speed (described below) when recording the images, and information indicating whether or not to control the position of the label paper 14 using the black mark sensor 42.

The job length is the length in the conveyance direction of an image recorded to the label paper 14 when executing one job. More specifically, the job length of job J1 in FIG. 4 is the length Q1 of the area SA1 in the conveyance direction, and the job length of job J2 is the length Q2 of area SA2 in the conveyance direction.

The gap length is the size of the gap (the separation between) the image data recorded to the label paper 14 when executing one job, and the image recorded to the label paper 14 when executing the next job after the one job, and more specifically is the length of the gap G1 formed between area SA1 and area SA2 in FIG. 4.

The conveyance speed is described below. More specifically, the printer-side control unit 27 in this embodiment conveys the label paper 14 in the conveyance direction at a predetermined specific speed while ejecting ink from the recording head and recording an image on the label paper 14, and the conveyance speed is this predetermined specific speed.

Note that the information included in the job-related information could be previously input by the user to the host computer 25, or previously acquired and detected by the host computer 25 using a specific means.

The printer-side control unit 27 gets the information described above based on the input job-related information (step SD1), and based on the acquired information determines the order of the processes related to executing the jobs (step SD2).

The process of this step SD2 is described next.

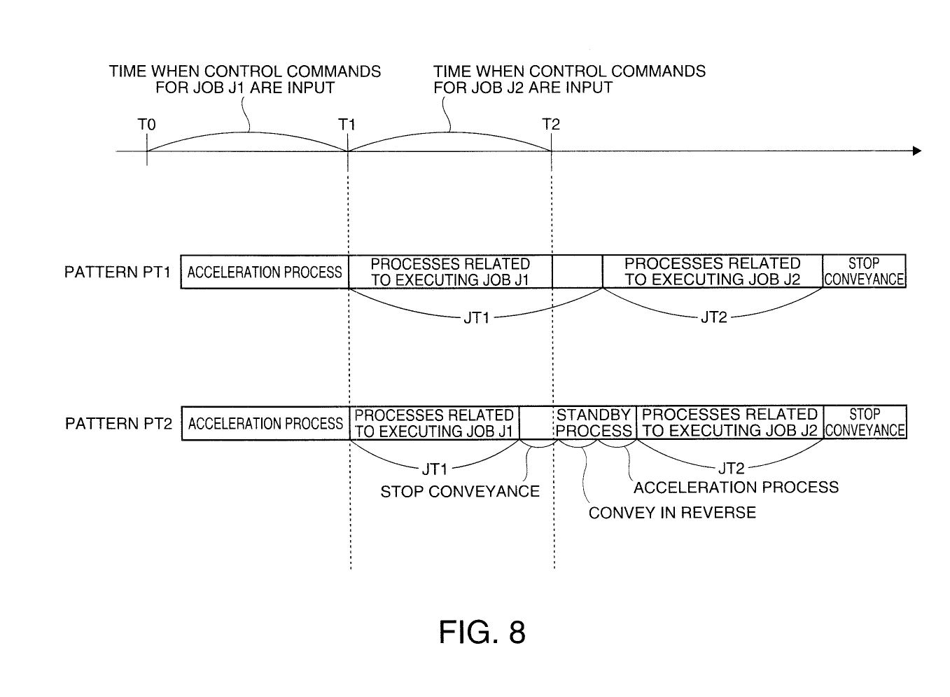

FIG. 8 is used to describe the process of step SD2. In FIG. 8 the x-axis shows the passage of time, and time passes from left to right in the figure.

When control commands related to job J1 and control commands related to job J2 are input sequentially, the printer-side control unit 27 determines the time T1 (the time passed from time T0) when input of control commands related to job J1 ends, and the time T2 (the time passed from time T0) when input of control commands related to job J2 ends, referenced to the time T0 when control command input starts based on the information denoting the data transfer rate of communications between the host computer 25 and the inkjet line printer 1, and the information denoting the amount of data in the control commands related to jobs scheduled to be output, which is contained in the job-related information.

More specifically, the printer-side control unit 27 first calculates the transmission time, which is the time from the start to the end of input of control commands related to the jobs, from the data transfer rate and the amount of data in the control commands related to the jobs, with consideration for the environment and conditions related to communication, such as transmission efficiency. In basic terms, the transmission time can be calculated using the formula (amount of data/data transfer rate).

The printer-side control unit 27 also calculates time T1 and time T2 to accommodate the time required for processes related to sending and receiving data, and any loss expected to occur, based on the calculated transmission time of the control commands related to the jobs.

The relationship between the calculated times T0, T1, T2 is shown in the x-axis in FIG. 8.

After calculating times T1 and T2, the printer-side control unit 27 calculates the time JT1 (FIG. 8) required to execute job J1 and the time JT2 (FIG. 8) required to execute job J2 based on the information denoting the job length of the jobs scheduled to be output, the gap length information, and the conveyance speed information contained in the job-related information.

More specifically, the label paper 14 is conveyed at a specific conveyance speed during image recording in this embodiment. As a result, when calculating the time JT1 required to execute job J1, for example, the printer-side control unit 27 compensates the quotient of the job length of job J1 (length Q1 of the area SA1 in the conveyance direction) divided by the conveyance speed to appropriately account for the length of the gap G1 and whether or not positioning is controlled using the black mark sensor 42 to get the time JT1 required to complete job J1. Note that because the length of time JT1 differs according to whether or not positioning is controlled using the black mark sensor 42, compensation corresponding to the use of this sensor is applied to calculate the time JT1.

The printer-side control unit 27 calculates the time JT2 required to execute job J2 in the same way.

After calculating times T1 and T2, the time JT1 required to complete job J1, and the time JT2 required to complete job J2, the printer-side control unit 27 determines the order of the job processes as follows.

As described above, the inkjet line printer 1 according to this embodiment of the invention records images after writing all image data to the image buffer 50, and the printer-side control unit 27 therefore starts executing one job after inputting the control commands for the one job is completed and all image data can be written to the image buffer 50.

As a result, the printer-side control unit 27 determines the order of the processes for each of the jobs job J1 and job J2 so that input of the control commands related to a job is completed when a job starts and the processes can be performed as efficiently as possible. This is described more specifically below using two patterns, pattern PT1 and pattern PT2 shown in FIG. 8, for example.

With pattern PT1 in FIG. 8, the printer-side control unit 27 determines the order of the processes with consideration for times T1 and T2 so that an acceleration process, job J1, job J2, and conveyance stopping process are executed sequentially in this order.

The acceleration process is a process in which an operation that is required to perform the jobs is executed. For example, this could be an operation related to preparing selected parts (such as the recording head) to record an image, or assigning values to variables defined by the program that controls image recording. During this acceleration process the printer-side control unit 27 conveys the label paper 14 to the position for starting job J1, and when this starting position is reached, gradually increases the speed of label paper 14 conveyance so that the label paper 14 conveyance speed reaches the predetermined speed.

The time required to complete this acceleration process can be predicted based on specific information such as the conveyance distance and the conveyance speed of the label paper 14 in the acceleration process, or predicted from the time required in past acceleration processes.

The printer-side control unit 27 schedules the timing of the acceleration process so that the acceleration process ends at time T1 by starting the acceleration process at an appropriate time (which may be a time before time T0) referenced to time T0.

Note that if predicting the time required to execute the acceleration process is difficult, the processes involved in the acceleration process can be scheduled by adjusting the conveyance speed of the label paper 14 in the acceleration process, or adjusting the processes performed in the acceleration process, so that the time when the acceleration process ends is time T1.

Next, the printer-side control unit 27 schedules job J1 so that execution of job J1 starts at time T1 after the acceleration process ends. By thus starting execution of job J1 at time T1, job J1 starts right after input of the control commands for job J1 is completed, and process efficiency improves.

Next, based on the time JT1 required to complete job J1, the printer-side control unit 27 determines which will come first chronologically, the time when job J1 ends or time T2. In pattern PT1 as shown in FIG. 8, the time when job J1 ends is chronologically after time T2 (the time when input of control commands for job J2 is completed). Input of the control commands for job J2 is therefore completed when job J1 ends, and execution of job J2 can start.

The printer-side control unit 27 therefore schedules job J2 so that execution of job J2 runs continuously to the completion of job J1. Executing job J2 continuously to job J1 means that job J1 and job J2 run continuously without pausing conveyance of label paper 14 while continuing conveyance in the conveyance direction at the predetermined specific speed, and record images in seal part S1 and seal part S2, respectively. In a recording device such as the inkjet line printer 1 according to this embodiment of the invention in which the recording medium 11 is conveyed relative to stationary recording heads and the recording heads are separated in the conveyance direction, continuously executing as many jobs that can be executed continuously as possible can further improve process efficiency and throughput. This is because, as shown in FIG. 1, the upstream top recording head 17T of the upstream head unit 17 and the downstream top recording head 18T of the downstream head unit 18, are separated in the conveyance direction in this embodiment. As a result, when recording an image to one seal part S, and recording an image to another seal part S separated from the one seal part S in the reverse of the conveyance direction, the upstream top recording head 17T can eject ink to part of one seal part S while the downstream top recording head 18T ejects ink to part of the other seal part S by executing jobs continuously, and as a result an image can be recorded to one seal part S and an image can be recorded to another seal part S while keeping the speed of label paper 14 conveyance in the specific direction constant. This also applies to the other recording heads.

However, when one job for recording an image on one seal part S and another job for recording an image on another seal part S are not executed continuously, conveyance pauses after recording an image on the one seal part S by executing one job, the label paper 14 is conveyed in the direction opposite the conveyance direction to the position for recording an image on the other seal part S, and the job related to recording an image on the other seal part S is then executed. This is extremely disadvantageous in terms of process efficiency and throughput compared with when jobs are executed continuously.

By executing job J2 continuously to job J1 in the case of pattern PT1, process efficiency and throughput can be improved as described above.

The printer-side control unit 27 schedules a process that stops label paper 14 conveyance after job J2 is completed.

As described in example 1, the printer-side control unit 27 sets a target position for the process that stops conveyance, and label paper 14 conveyance is stopped at the target position after conveying the label paper 14 the minimum required. The effect of stopping conveyance at a target position after the minimum required conveyance is the same as described in example 1.

Operation in pattern PT2 in FIG. 8 is described next.

In pattern PT2, the printer-side control unit 27 schedules the timing of the acceleration process so that the acceleration process ends at time T1 and execution of job J1 starts at time T1.

In the example shown in pattern PT2, the time when job J1 ends is chronologically before time T2, input of control commands for job J2 is therefore not completed when job J1 ends, and executing job J2 cannot start.

The printer-side control unit 27 therefore schedules a standby process so that the standby process executes after job J1.

A process that stops label paper 14 conveyance in conjunction with completion of job J1 runs first in this standby process. As in example 1, a target position is set by the printer-side control unit 27 for this process that stops conveyance, and label paper 14 conveyance stops at this target position after the label paper 14 is conveyed the required minimum. The effect of stopping conveyance at the target position after the minimum required conveyance is as described in example 1.

Next, the printer-side control unit 27 then determines the order of processes so that the label paper 14 is conveyed a specific distance in reverse of the conveyance direction, and the label paper 14 is moved to the position where job J2 can start. The position where job J2 can start is a position that reflects conveyance of the label paper 14 in a process equivalent to the acceleration process described above. When job J1 and job J2 are not executed continuously and job J1 runs independently, the label paper 14 is positioned to a location past the starting position of job J2 in the conveyance direction when job J1 ends, and the label paper 14 must therefore be conveyed in reverse of the conveyance direction before starting job J2. Note that this state is unique to the inkjet line printer 1 according to this embodiment of the invention in which the upstream head unit 17 and downstream head unit 18 are separated in the conveyance direction. In addition, the printer-side control unit 27 performs an acceleration process after a process that moves to a position where job J2 can start. The printer-side control unit 27 schedules the acceleration process so that the time when the acceleration process ends is chronologically after time T2.

If input of control commands for job J2 is not completed when job J1 ends, the printer-side control unit 27 schedules the processes so that a standby process runs between job J1 and job J2 to wait until the control commands for job J2 are input. During this standby process operations required to start executing job J2 are performed while waiting for input of control commands related to job J2 to end.

As may be appropriate, the printer-side control unit 27 may schedule the flushing process described above to execute during this standby process. Flushing is possible during the standby process because an image is not recorded by ejecting ink. If flushing is completed while waiting, the standby process, which is a process that must be executed when executing one job if input of the control commands related to that one job is not completed, can be beneficially used to perform the flushing process.

In addition, the printer-side control unit 27 schedules the job J2 to execute after the acceleration process in the standby process in pattern PT2. When executing this job J2 starts, input of control commands related to job J2 is completed, and executing job J2 can therefore start.

The printer-side control unit 27 schedules the process that stops label paper 14 conveyance after job J2 executes. As in example 1 above, a target position is set by the printer-side control unit 27 for the process that stops conveyance, and label paper 14 conveyance stops at this target position after the label paper 14 is conveyed the required minimum. The effect of stopping conveyance at the target position after the minimum required conveyance is as described in example 1.

Referring again to FIG. 7, after the order of the steps involved with job execution is determined in step SD2, the printer-side control unit 27 outputs a command requesting job input to the host computer 25 (step SD3).

When a job is input from the host computer 25, the printer-side control unit 27 starts counting the time passed since the start of job input (time T0) (step SD4).

Next, the printer-side control unit 27 calculates the elapsed time when time T1 comes, and the elapsed time when time T2 comes, referenced to when counting the elapsed time started (time T0), and runs the process related to job execution according to the order determined in step SD2 referenced to time T1 and time T2. For example, if the order determined in step SD2 is a sequence such as shown in pattern PT1 in FIG. 8, the printer-side control unit 27 starts running job J1 at time T1 referenced to the start of job input as time T0, executes job J2 continuously after the end of job J1, and executes the process that stops label paper 14 conveyance after job J2 ends.

Because an efficient job order that appropriately reflects the timing when input of control commands related to the jobs scheduled to be input ends based on the acquired job-related information can thus be determined, and the processes related to job execution are sequentially performed based on this job order, the processes related to executing the jobs can be performed efficiently.

As described above, the inkjet line printer 1 according to this embodiment of the invention sequentially executes the input jobs when jobs that execute processes related to image recording are input continuously from the information output unit 55 of a host computer 25, which is a control device. When a job is input, the printer-side control unit 27 of the inkjet line printer 1 gets job-related information related to the input jobs from the host computer 25, and based on the acquired job-related information determines the order in which the processes related to the input jobs are executed.

As a result, because before the jobs are actually executed the order of the job-related processes is determined to reflect the content of the input jobs based on the job-related information acquired from the host computer 25, the job-related processes can be sequentially executed in an efficient order according to the content of the jobs input from the host computer 25 by executing the job-related processes according to this order.

The printer-side control unit 27 according to this embodiment of the invention also determines the order of the processes related to executing the input jobs based on the acquired job-related information so that a process that stops conveyance of the label paper 14, which is the recording medium, is executed at the end of recording the image of the job that is executed last.

As a result, conveying the label paper 14 unnecessarily after recording the image related to the job that is executed last ends can be prevented, and the job-related processes can be performed efficiently. In addition, the conveyance distance that the label paper 14 is reversed from the conveyance direction in order to start a job when a new job is executed can be reduced, the time required to reverse the label paper 14 can be shortened, and throughput can be improved.

The printer-side control unit 27 in this embodiment of the invention determines the order of processes related to the input jobs based on the acquired job-related information so that a process that stops conveyance of the label paper 14 is executed at the end of recording the image of the job that is executed last and conveyance stops at a specific target position.

As a result, because conveying the label paper 14 unnecessarily after recording the image related to the job that is executed last ends can be prevented, and the relative position of the label paper 14 after conveyance stops can be controlled, the label paper 14 can be efficiently conveyed in the reverse of the conveyance direction when necessary in order to start a job when a new job is to be executed.

In this embodiment of the invention the job-related information includes at least information indicating the number of jobs to be input, and the printer-side control unit 27 determines the last job to be executed in the group of input jobs based on the information denoting the number of jobs included in the job-related information.

As a result, the information denoting the number of jobs included in the job-related information can be used to appropriately determine which of the input jobs is the job to be executed last.

This embodiment of the invention records images in a page mode. More specifically, image data for images to be recorded to label paper 14 is included in the control commands (data related to one job) for one job, the inkjet line printer 1 writes the image data included in the data to a specific buffer after the control commands for the one job are input, and records an image based on the stored image data. All control commands related to the one job must therefore be input before the one job is executed. The printer-side control unit 27 then determines the order of the processes related to the input jobs based on the job-related information so that reception of data related to each job is completed when the job starts.

Furthermore, because the order of the processes related to the jobs is determined so that reception of the control commands related to each job is completed before the job starts, this embodiment of the invention can sequentially execute job-related processes in an efficient order according to the actual reception of data related to each job by executing the job processes as scheduled.

The printer-side control unit 27 in this embodiment of the invention determines the order of processes related to input jobs based on job-related information so that a standby process, which waits for reception of data related to the next job to end, executes after executing one job ends when reception of the data for the next job, which is executed next after the one job, is not expected to be completed by the time the one job ends.

As a result, job-related processes are scheduled so that a standby process runs appropriately between one job and the next job, and reception of data related to each job can be completed before each job executes.

In this embodiment the job-related information at least includes information denoting the data transmission rate in communication with the host computer 25, and information related to the amount of data in the control commands of each job. Based on the data transmission rate information and information related to the amount of data contained in the job-related information, the printer-side control unit 27 predicts the time (times T1 and T2) when inputting data related to each job will be completed when data related to plural jobs is input sequentially, and based on these times determines the order of the processes related to the input jobs so that reception of data for each job is completed when each job starts.

As a result, based on information denoting the data transmission rate and information related to the amount of data in the control commands of each job that is included in the job-related information, the time when inputting data related to each job will be completed when data related to plural jobs is input sequentially can be predicted, and based on these predicted times the order of the processes related to the input jobs can be determined so that reception of data for each job is completed when each job starts.

The job-related information in this embodiment also includes information (job length) related to the length in the conveyance direction of an image recorded to the label paper 14 by executing each job. Based on the job length of each job included in the job-related information, and the conveyance speed of the label paper 14, the printer-side control unit 27 predicts the time required for each job, and based on the predicted time required for each job, and the predicted times T1 and T2, determines the order of the processes related to the input jobs so that reception of data for each job is completed when each job starts.

As a result, the time required to execute each job can be appropriately predicted based on information denoting the job length included in the job-related information and the conveyance speed of the label paper 14, and the order of the processes related to the input jobs can be determined using the time required for each job predicted to reflect the time when input of data related to each job is completed when data for plural jobs is input sequentially so that reception of data related to each job is completed when executing each job starts.

The printer-side control unit 27 controls these operations in the embodiment described above. More specifically, the CPU of the printer-side control unit 27 reads a program stored in ROM, and executes the program. This program can also be stored on a storage medium such as a hard disk drive or semiconductor memory.

It will be obvious to one with ordinary skill in the related art that the foregoing embodiment is one example, and can be modified and adapted in many ways without departing from the scope of the accompanying claims.

For example, when recording an image on the label paper 14, the inkjet line printer 1 in the above embodiment conveys the label paper 14 at a predetermined conveyance speed while recording images. However, considering that reception of control commands related to each is completed before each job is executed, and considering improving process efficiency, a configuration that adjusts the conveyance speed based on information included in the job-related information is also conceivable.

The configuration of the recording heads, the configuration of the mechanisms used for recording, the means of flushing, the configuration of the mechanisms used for flushing, and other aspects of the foregoing embodiment are obviously also not limited to the embodiment described above. More specifically, in addition to a print head that records by ejecting ink from an inkjet head onto a recording medium conveyed in a conveyance direction, the invention can be broadly applied to recording devices having thermal head or other type of print head.

What is claimed is:

1. A recording device that can connect to a control device and comprises:
a conveyance unit that conveys a recording medium;
a print head that records to the recording medium conveyed by the conveyance unit;
a reception unit that receives a job related to recording an image from the control device; and
a control unit that controls the conveyance unit and the print head, and records on the recording medium, by executing the received job, and
when executing a plurality of jobs, receives job-related information related to at least one job by the reception unit from the control device, and determines a sequence of processes related to executing the plural jobs, including at least a sequence that stops conveyance by the conveyance unit at a specific target position of the recording medium, based on the received job-related information.

2. The recording device described in claim 1, wherein:
the control unit, based on the job-related information received by the reception unit, determines a sequence of processes related to executing the plural jobs so that a process that stops conveyance by the conveyance unit is executed and conveyance of the recording medium is stopped at the specific target position when executing the last job in the group of plural jobs ends.

3. The recording device described in claim 1, wherein:
at least information indicating the number of jobs that will be received is included in the job-related information; and
the control unit determines the specific target position of the recording medium at which conveyance by the conveyance unit stops based on the information indicating the number of jobs.

4. The recording device described in claim 1, further comprising:
a storage unit with a buffer;
wherein image data for an image to be recorded to the recording medium is included in the job; and
the control unit stores the image data contained in the job to the buffer by page unit and records the stored image data to the recording medium when executing the job, and
determines the specific target position of the recording medium at which conveyance by the conveyance unit stops by page unit.

5. The recording device described in claim 1, wherein:
information related to image data contained in the jobs is included in the job-related information; and
the control unit determines the specific target position of the recording medium at which conveyance by the conveyance unit stops based on the information related to the image data.

6. The recording device described in claim 5, wherein:
information related to the amount of data in the job is included in the information related to the image data; and
the control unit determines the specific target position of the recording medium at which conveyance by the conveyance unit stops based on the information related to the amount of data.

7. The recording device described in claim 1, wherein:
information indicating a data transfer rate in communications with the control device is included in the job-related information; and
the control unit determines the specific target position of the recording medium at which conveyance by the conveyance unit stops based on the data transfer rate information.

8. The recording device described in claim 1, wherein:
information related to the length in the conveyance direction of the image recorded to the recording medium by executing each job is included in the job-related information; and
the control unit determines the specific target position of the recording medium at which conveyance by the conveyance unit stops based on the information related to each length.

9. A method of controlling a recording device that has a conveyance unit that conveys a recording medium, and a print head that records to the recording medium conveyed by the conveyance unit, and can connect to a control device, the control method comprising steps of:
receiving a job related to recording an image from the control device;
operating the conveyance unit and the print head and recording based on the received job;
receiving job-related information related to at least one job from the control device; and
determining a sequence of processes related to executing the plural jobs, including at least a sequence that stops conveyance by the conveyance unit at a specific target position of the recording medium, based on the received job-related information.

10. The method of controlling a recording device described in claim 9, further comprising a step of:
determining, based on the job-related information received by the reception unit, a sequence of processes related to executing the plural jobs so that a process that stops conveyance by the conveyance unit is executed and conveyance of the recording medium is stopped at the specific target position when executing the last job in the group of plural jobs ends.

11. The method of controlling a recording device described in claim 9, wherein:
at least information indicating the number of jobs that will be received is included in the job-related information; and
the control method further comprises a step of determining the specific target position of the recording medium at which conveyance by the conveyance unit stops based on the information indicating the number of jobs.

12. The method of controlling a recording device described in claim 9, wherein:
image data for an image to be recorded to the recording medium is included in the job; and
the control method further comprises steps of :
storing the image data contained in the job to a buffer by page unit, and recording the stored image data to the recording medium when executing the job; and
determining the specific target position of the recording medium at which conveyance by the conveyance unit stops by page unit.

13. The method of controlling a recording device described in claim 9, wherein:
information related to image data contained in the jobs is included in the job-related information; and
the control method further comprises a step of determining the specific target position of the recording medium at which conveyance by the conveyance unit stops based on the information related to the image data.

14. The method of controlling a recording device described in claim 9, wherein:
information related to the amount of data in the job is included in the information related to the image data; and
the control method further comprises a step of determining the specific target position of the recording medium at which conveyance by the conveyance unit stops based on the information related to the amount of data.

15. The method of controlling a recording device described in claim 9, wherein:
information indicating a data transfer rate in communications with the control device is included in the job-related information; and
the control method further comprises a step of determining the specific target position of the recording medium at which conveyance by the conveyance unit stops based on the data transfer rate information.

16. The method of controlling a recording device described in claim 9, wherein:
information related to the length in the conveyance direction of the image recorded to the recording medium by executing each job is included in the job-related information; and
the control method further comprises a step of determining the specific target position of the recording medium at which conveyance by the conveyance unit stops based on the information related to each length.

17. A storage medium that stores a program executed by a control unit that controls parts of a recording device that has a conveyance unit that conveys a recording medium, and a print head that records to the recording medium conveyed by the conveyance unit, and can connect to a control device, the program causing the control unit to perform steps including:
receiving a job related to recording an image from the control device;
operating the conveyance unit and the print head and recording on the recording medium based on the received job;
receiving job-related information related to at least one job from the control device when recording a plurality of jobs; and
determining a sequence of processes related to executing the plural jobs, including at least a sequence that stops conveyance by the conveyance unit at a specific target position, based on the received job-related information.
